(19) United States
(12) Patent Application Publication
(10) Pub. No.: US 2026/0250136 A1
(43) Pub. Date: Aug. 27, 2026

(54) AMORPHOUS GRAPHITIC CARBON MATERIAL AND METHOD OF PRODUCING

(71) Applicant: UT-Battelle, LLC, Oak Ridge, TN (US)

(72) Inventors: Bishnu P. Thapaliya, Knoxville, TN (US); Saurabh Prakash Pethe, Knoxville, TN (US); Sheng Dai, Knoxville, TN (US); M Parans Paranthaman, Knoxville, TN (US)

(21) Appl. No.: 19/547,880

(22) Filed: Feb. 24, 2026

Related U.S. Application Data
(60) Provisional application No. 63/763,531, filed on Feb. 26, 2025.

(51) Int. Cl. C01B 32/205; H01M 4/583; H01M 10/054; H01M 4/02

(52) U.S. Cl. CPC C01B 32/205; H01M 4/583; H01M 10/054; C01P 2002/02; C01P 2002/04; C01P 2002/72; C01P 2002/82; C01P 2004/04; C01P 2006/16; C01P 2006/40; H01M 2004/021; H01M 2004/027

(57) ABSTRACT

A carbon composition useful as a sodium-ion battery anode material, the composition comprising an amorphous carbon material containing randomly oriented graphene platelets along with the following additional features: (i) nanovoids contoured by layers of the graphene platelets, wherein the nanovoids have a size of 2-20 nm; (ii) sub-nanopores that traverse said layers and having a size of 0.2-0.6 nm; and (iii) microchannels connecting between said nanovoids, wherein said microchannels have a width less than 2 nm Further described herein are sodium-ion and potassium-ion batteries containing the carbon composition incorporated into an anode of the battery. Further described herein is a method for producing the carbon composition by gradual heating of a carbonaceous precursor material such as biomass or plastic waste.

### CROSS-REFERENCE TO RELATED APPLICATIONS

This application claims priority from U.S. Provisional Application No. 63/763,531, filed February 26, 2025, which is herein incorporated by reference in its entirety.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to the field of amorphous porous carbon materials, and more particularly, such carbon materials useful as anodic materials in alkali-ion batteries, as well as methods of producing such carbon materials by carbonization of precursor materials using a gradual heating process.

### BACKGROUND

The growing demand for energy storage devices, particularly in electric vehicles and grid-scale applications, has surpassed the supply capabilities of commercially viable lithium-ion batteries (LIBs). This disparity is driven by the limited reserves and uneven geographic distribution of lithium resources, compounded by geopolitical complexities. Consequently, sodium-ion batteries (SIBs) have garnered significant interest as a viable alternative, particularly in view of abundant sodium resources, lower costs, and compatibility with existing LIB manufacturing infrastructure. Moreover, the reduced production expenses of SIBs compared to LIBs positions SIBs as an attractive choice for large-scale projects like grid storage, where cost considerations are crucial. Their affordability not only makes them attractive but also supports broader adoption in consumer electronics and industrial applications, contributing to the transition toward sustainable energy solutions.

Although SIBs share comparable physicochemical and electrochemical characteristics with LIBs, their development has been hindered by the suboptimal performance of currently available carbon anode materials. A critical factor in SIB performance is the use of customized hard carbon as the anode material. Its tailored microstructural properties permit consistent low-voltage sodium-ion storage. However, currently available hard carbon materials do not optimally meet the stringent requirements for SIB applications, which in turn increases costs. This highlights a critical need for cost-effective, high energy density hard carbon anodes capable of facilitating sodium-ion storage at low and stable voltages to meet market demands.

Thus, the production of high energy density carbon materials specifically adapted to provide exceptional performance in SIBs would be a significant advance in the field of porous carbon materials. The method would be further advantageous if it can produce such high performance carbon materials by straightforward and cost-efficient means.

### SUMMARY

In one aspect, the present disclosure is directed to amorphous porous carbon materials (i.e., “carbon materials”) specially designed to function as high performance anodic materials in SIBs. As demonstrated later in this disclosure, the carbon materials described herein advantageously provide exceptional performance in SIBs, including high-voltage, high-energy density and remarkable sodium-ion storage at low and stable voltages. The carbon materials described herein also advantageously provide excellent cycling stability and efficient ion transport.

More particularly, the amorphous carbon materials described herein contain randomly oriented graphene platelets along with the following additional features: (i) nanovoids contoured by layers of the graphene platelets, wherein the nanovoids have a size of 2-20 nm; (ii) sub-nanopores that traverse the layers and having a size of 0.2-0.6 nm; and (iii) microchannels connecting between the nanovoids, wherein the microchannels have a width less than 2 nm.

In a first set of embodiments, the nanovoids have a size of 2-10 nm or 2-5 nm. In a second set of embodiments, the sub-nanopores have a size of 0.3-0.6 nm, 0.2-0.5 nm, or 0.3-0.5 nm. In a third set of embodiments, the microchannels have a width of 0.1-1 nm, 0.1-0.7 nm, 0.1-0.5 nm, 0.2-0.9 nm, 0.2-0.7 nm, or 0.2-0.5 nm. In a fourth set of embodiments, the amorphous carbon material includes pores larger than 1 nm (typically up to 3, 4, or 5 nm) or alternatively excludes pores larger than 1 nm (or larger than 2, 3, 4, or 5 nm). In a fifth set of embodiments, the amorphous carbon material includes sodium and/or potassium ions. In a sixth set of embodiments, the amorphous carbon material has a defect-rich structure characterized by a D-band to G-band intensity (I_{D}/I_{G}) ratio in a range of 2-4 as determined by Raman spectroscopy. In a seventh set of embodiments, the amorphous carbon material exhibits a d-spacing of 0.36-0.5, or more particularly, 0.36-0.46, or about 0.38. In an eighth set of embodiments, the amorphous carbon material includes closed nanovoids (i.e., non-porous nanovoids) or alternatively excludes closed nanovoids. In a ninth set of embodiments, the amorphous carbon material possesses a 9-10 vol% pore micropore volume. In a tenth set of embodiments, the amorphous carbon material possesses a surface area of at least 10, 20, 30, 40, or 50 m²/g and up to 80, 90, or 100 m²/g. In an eleventh set of embodiments, the amorphous carbon material possesses a purity of at least 90, 92, or 95 wt.% carbon, the remaining wt.% (e.g., up to or less than 10 wt.%) attributed to oxygen. In a twelfth set of embodiments, the amorphous carbon material exhibits a capacity of sodium storage of at least or greater than 250, 300, or 350 mAh/g at a current density of 20-40 mA/g or about 30mA/g. In a thirteenth set of embodiments, the amorphous carbon material exhibits a stable capacity of at least or over 200 or 250 mAh g⁻¹ for at least or more than 2000, 2500, or 3000 cycles at a high current rate of at least or greater than 1 A g⁻¹. Moreover, any two or more of the foregoing first through thirteenth embodiments may be combined to result in a porous carbon composition possessing more than one of the physical features or properties enumerated above.

In another aspect, the present disclosure is directed to a sodium-ion or potassium-ion battery containing any of the above described porous carbon materials in an anode of the battery. The battery more particularly contains the following components: (a) an anode; (b) a cathode; and (c) an electrolyte composition in contact with the anode and cathode. The electrolyte may be a liquid, gel, or solid electrolyte composition. The resulting battery may exhibit any of the exceptional performance characteristics mentioned above for the carbon material, e.g., high and stable capacity over long cycling periods.

In another aspect, the present disclosure is directed to a method for producing the above-described carbon materials. The method, which is advantageously cost-efficient and straightforward, employs a novel sintering approach to produce carbon materials with the above described finely tuned microstructure. The process involves the controlled sintering of carbonaceous material at elevated (carbonizing) temperatures. In some embodiments, the method advantageously makes use of carbonaceous material generally regarded as waste (i.e., “waste material”) as the precursor material, which may be, for example, biomass or plastic. The method employs a straightforward gradual sintering process to modify the microstructural architecture of carbonaceous materials. More particularly, the method involves subjecting a carbonaceous precursor material to a heating process that includes an initial gradual temperature increase at a rate of 0.5-2 °C/min to a maximum temperature within a range of 800-1300°C followed by maintaining the maximum temperature for a period of time of 1-18 hours, wherein the heating process is conducted under an inert atmosphere. In some embodiments of the method, the initial gradual temperature increase is conducted at a rate of 0.5-1 °C/min. In separate or further embodiments of the method, the maximum temperature is within a range of 900-1200°C, or a range of 1000-1200°C, or a range of 1050-1150°C. In separate or further embodiments, the maximum temperature, such as any of those exemplified above, is maintained for a period of time of 6-18 hours, 8-18 hours, 6-15 hours, or 8-15 hours. In separate or further embodiments, prior to the initial gradual temperature increase, the heating process includes a fast heating step at a rate of at least 5°C/min up to a temperature at or below 900°C, after which the initial gradual temperature increase brings the temperature to the maximum temperature. In separate or further embodiments, the fast heating step is conducted at a rate of at least 10°C/min, 15°C/min, or 20°C/min. The above described method, which may include any one or more of the particular embodiments above, is capable of producing any of the types of carbon materials described earlier above.

In particular embodiments of the method, biomass and/or plastic waste may be treated at a high temperature (e.g., 1100 °C for 12 hours) under an inert atmosphere, using a controlled and gradual heating rate to transform the carbonaceous material into a novel porous carbon material as described above. The resulting carbon material is a high-energy density material suitable for SIB applications. Notably, as the accumulation of plastic waste is a growing concern around the world, the use of such waste in the production of high performance carbon material makes the process even more economical while also being beneficial to the environment.

### BRIEF DESCRIPTION OF THE DRAWINGS

FIGS. 1a-1b. FIG. 1a is an XRD pattern and FIG. 1b is a Raman spectrum of as synthesized hard carbon from biomass at ~1100 °C. The I _{D}/I Gratio is ~3.2.

FIGS. 2. CV plot for as synthesized hard carbon anode from biomass at ~1100 °C for SIB from 0.005 to 2.00 V vs. Na/Na⁺.

FIGS. 3a-3d. FIG. 3a is a plot showing specific capacities and coulombic efficiency of as-synthesized hard carbon anode from biomass at ~1100 °C cycled from 0.005 – 2.00 V at 30 mA g⁻¹ for first 2 cycles and 100mA g⁻¹ for the rest of the cycles; FIG. 3b is a charge-discharge voltage profile for the first three cycles; FIG. 3c is a plot of charge discharge capacities and coulombic efficiencies from 30 to 2000 mAh g⁻¹ current densities; and FIG. 3d is a plot of charge-discharge capacities and coulombic efficiency at 1000 mA g⁻¹ current density for 2000 cycles showing stable capacity > 200 mAhg⁻¹ at an average coulombic efficiency > 99.95 %.

FIGS. 4a-4d. FIG. 4a is an XRD pattern and FIG. 4b is a Raman spectrum of as synthesized hard carbon from plastic waste at ~1300 °C. The I _{D}/I Gratio is ~2.65; FIG. 4c is a plot showing specific capacities and coulombic efficiency of as-synthesized hard carbon anode from recycled plastic waste cycled from 0.005 – 2.00 V at 30 mA g⁻¹ for first 2 cycles and 100 mA g⁻¹ for the rest of the cycles; and FIG. 4d is a charge-discharge voltage profile for the first five cycles.

FIGS. 5a-5d. FIG. 5a is a plot showing specific capacities and coulombic efficiency of as-synthesized hard carbon anode from polyacrylonitrile from 0.005 – 2.00 V at 30 mA g⁻¹ for first 2 cycles and 100 mA g⁻¹ for the rest of the cycles; FIG. 5b is a charge-discharge voltage profile for the first two cycles; FIG. 5c is a plot showing specific capacities and coulombic efficiency of as-synthesized hard carbon anode from lignin from 0.005 – 2.00 V at 30 mA g⁻¹ for first 2 cycles and 100 mA g⁻¹ for the rest of the cycles; and FIG. 5d is a charge-discharge voltage profile for the first two cycles.

FIGS. 6a-6b. FIG. 6a is a high resolution scanning transmission electron microscopy HAADF image and FIG. 6b is a bright field image of hard carbon synthesized at ~ 1100 °C. The black pointed arrows show the semi-closed nanovoids in the carbon structure.

FIGS. 7a-7b. FIG. 7a is an XRD pattern and FIG. 7b is a Raman spectrum of as synthesized hard carbon from biomass at ~1300 °C. The I _{D}/I Gratio is ~2.6.

FIG. 8. CV plot for as synthesized hard carbon anode from biomass at ~1300 °C for SIB from 0.005 to 2.00 V vs. Na/Na⁺.

FIGS. 9a-9d. FIG. 9a is a plot showing specific capacities and coulombic efficiency of as-synthesized hard carbon anode from biomass at ~1300 °C cycled from 0.005 – 2.00 V at 30 mA g⁻¹ for first 2 cycles and 100 mA g⁻¹ for the rest of the cycles. FIG. 9b is a charge-discharge voltage profile for the first three cycles. FIG. 9c is a plot of charge discharge capacities and coulombic efficiencies from 30 to 2000 mAh g⁻¹ current densities. and FIG. 9d is a plot of charge-discharge capacities and coulombic efficiency at 1000 mA g⁻¹ current density for 2000 cycles showing stable capacity > 150 mAh g⁻¹ at an average coulombic efficiency > 99.95 %.

FIGS. 10a-10b. FIG. 10a is a high-resolution scanning transmission electron microscopy HAADF image and FIG. 10b is a bright field image of hard carbon synthesized at ~ 1300 °C. The black pointed arrow showed the semi-closed nanovoids in the carbon structure.

### DETAILED DESCRIPTION

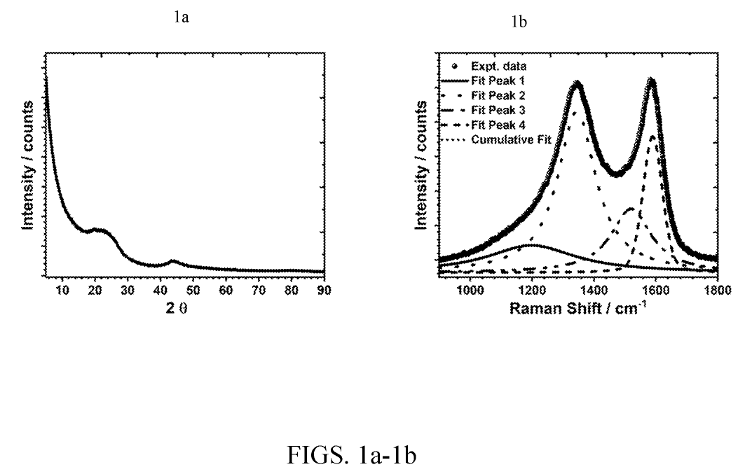

In a first aspect, the present disclosure is directed to a hard amorphous carbon material (i.e., “carbon material”) having characteristics that make it particularly suited as an anode material for a sodium-ion or potassium-ion battery. The carbon composition is amorphous by virtue of a random orientation of graphene platelets in layers of the carbon material. As used herein, “amorphous” refers to a carbon material lacking long-range three-dimensional crystallographic order. Although the material may contain graphene-like domains, such domains are randomly oriented and do not exhibit the periodic stacking characteristic of crystalline graphite. Accordingly, the material is considered amorphous despite containing locally graphitic structures. In some embodiments, the carbon material is completely (i.e., 100%) amorphous, which corresponds to completely non-crystalline (i.e., 0% crystalline). In other embodiments, the carbon material may have a trace of crystallinity, which is typically no more than or less than 5%, 2%, or 1% crystallinity. A drawing showing the primary features in the amorphous carbon material is provided in FIG. 1. As shown in FIG. 1, the amorphous carbon material (1) contains at least the following features: (i) nanovoids (3) contoured by layers of the graphene platelets (2), wherein the nanovoids have a size of 2-20nm; (ii) sub-nanopores (4) that traverse the layers and having a size within a range of 0.2-0.6 nm; and (iii) microchannels (5) connecting between the nanovoids, wherein the microchannels have a width less than 2 nm. In some embodiments, the carbon material contains sodium or potassium ions. In other embodiments, the carbon material does not contain sodium or potassium ions, or the carbon material does not contain any alkali ions.

As a first primary feature, the carbon material contains nanovoids contoured by layers of the graphene platelets (i.e., “layers”). The term “contoured,” as used herein, is intended to mean “outlined,” “bordered,” or “circumscribed”. Stated differently, the nanovoids are considered empty (although, typically, gas-filled or liquid-filled) spaces that are enclosed or surrounded by (and have a shape defined by) the graphene platelets. The nanovoids are enclosed by the graphene layers except for the presence of sub-nanopores, as further discussed below. A layer of graphene platelets may have the thickness of single platelets or may have the thickness of two or more bundled platelets or may (or may not) vary in its thickness along its length. A layer of graphene platelets may have a variation in its thickness or may be substantially uniform in thickness. The nanovoids have a size (typically an average size) of 2-20nm. In some embodiments, the nanovoids have a substantially or approximately circular or elliptical shape. In other embodiments, the nanovoids have an amorphous shape. The size of a non-circular nanovoid may refer to the longest dimension of the nanovoid or to an average of all three dimensions of the nanovoid. In various embodiments, at least 80%, 90%, or 95% (which may be numerical or volume percentage), or all (100%) of the nanovoids have a size within a range of 2-20 nm, 2-15 nm, 2-10 nm, 2-8 nm, 2-5 nm, 3-20 nm, 3-15 nm, 3-10 nm, 3-8 nm, 3-5 nm, 5-20, 5-15 nm, 10-20 nm, or 10-15 nm. In a case where less than 100% (i.e., 100-x %) of nanovoids have a size within a range of 2-20 nm, the remainder of the nanovoids (i.e., “x portion”) may have a size less than 2 nm and/or above 20 nm and up to or less than 30, 40, or 50 nm. In any event, nanovoids having a size of or greater than 30, 40, or 50 nm are typically absent. In a case where less than 100% of nanovoids have a size in a range having an upper limit less than 20nm (e.g., 2-5 nm), the remainder of the nanovoids typically have a size below 2 nm and/or above the upper limit of the range and no more than 20 nm, although it is possible that some of the nanovoids (e.g., no more than or less than 1, 2, 5, or 10%) may have a size above 20 nm but no more than 30, 40, or 50 nm. In some embodiments, the carbon material includes closed nanovoids (i.e., non-porous nanovoids), which results in the presence of both porous and non-porous nanovoids in the carbon material. In other embodiments, the carbon material excludes closed nanovoids.

As a second primary feature, the carbon material contains sub-nanopores that traverse the layers of graphene platelets. The term “sub-nanopore,” as used herein, indicates a gap within the layer having a size below 1 nm. The sub-nanopore may be substantially straight or may follow a serpentine (i.e., winding or tortuous) path through the layer of graphene platelets. The term “traverse,” as used herein, indicates that the sub-nanopore is an empty space that permits the passage of gas and/or liquid in and out of the nanovoid. The sub-nanopores have a size of 0.2-0.6 nm. In various embodiments, the sub-nanopores have a size in a range of 0.2-0.5 nm, 0.2-0.4 nm, 0.2-0.3 nm, 0.3-0.6 nm, 0.3-0.5 nm, 0.3-0.4 nm, 0.4-0.6 nm, or 0.4-0.5 nm. In some embodiments, the only pores present in the carbon material are sub-nanopores within any of the size ranges provided above. In some embodiments, the carbon material further includes pores having a size greater than 0.6 nm or a size of 0.7- 1 nm, provided that the vol% attributed to such larger pores is no more than or less than 10, 5, 2, or 1 vol%. In some embodiments, pores having a size greater than 0.6 nm or having a size of 0.7-1 nm are excluded. In separate or further embodiments, the carbon material may include pores larger than 1 nm (e.g., pores having a size of or no more than 2, 3, 4, or 5 nm), provided that the vol% attributed to such larger pores is no more than or less than 10, 5, 2, or 1 vol%. In some embodiments, pores having a size greater than 1 nm, 2 nm, 3 nm, or 4 nm are excluded. Notably, any of the nanovoid types and sizes described above may contain any of the types and sizes of sub-nanopores provided above. Thus, any of the nanovoid types and sizes described above may be selected and combined with any of the types and sizes of sub-nanopores provided above to result in a carbon material containing a particular combination of such features.

As a third primary feature, the carbon material contains microchannels (i.e., “microchannels”) connecting between the nanovoids. The microchannels are considered empty (although, typically, gas-filled or liquid-filled) spaces with a shape defined by graphitic carbon. The microchannels may be substantially straight or may follow a serpentine (i.e., winding or tortuous) path. The microchannels have a width less than 2 nm. The microchannels may have a width of precisely or about, for example, 0.1 nm, 0.2 nm, 0.3 nm, 0.4 nm, 0.5 nm, 0.6 nm, 0.7 nm, 0.8 nm, 0.9 nm, 1 nm, 1.1 nm, 1.2 nm, 1.3 nm, 1.5 nm, 1.6 nm, 1.7 nm, or 1.8 nm, or a width within a range bounded by any two of the foregoing values, e.g., a width of 0.1-1.8 nm, 0.1-1.5 nm, 0.1-1.2 nm, 0.1-1 nm, 0.1-0.7 nm, 0.1-0.5 nm, 0.2-1.8 nm, 0.2-1.5 nm, 0.2-1.2 nm, 0.2-1 nm, 0.2-0.7 nm, 0.2-0.5 nm, 0.3-1.8 nm, 0.3-1.5 nm, 0.3-1.2 nm, 0.3-1 nm, 0.3-0.7 nm, 0.3-0.5 nm, 0.4-1.8 nm, 0.4-1.5 nm, 0.4-1.2 nm, 0.4-1 nm, 0.4-0.7 nm, 0.5-1.8 nm, 0.5-1.5 nm, 0.5-1.2 nm, 0.5-1 nm, 0.6-1.8 nm, 0.6-1.5 nm, 0.6-1.2 nm, 0.6-1 nm, 0.7-1.8 nm, 0.7-1.5 nm, 0.7-1.2 nm, 0.7-1 nm, 0.8-1.8 nm, 0.8-1.5 nm, 0.8-1.2 nm, 0.8-1 nm, 1-1.8 nm, or 1-1.5 nm. Notably, any of the nanovoid types and sizes described may be selected and combined with any of the types and sizes of sub-nanopores provided above and this may be selected and combined with any of the types and sizes of microchannels described above to result in a carbon material containing a particular combination of such features.

In some embodiments, the carbon material has a defect-rich structure characterized by a D-band to G-band intensity (I_{D}/I_{G}) ratio in a range of 2-4 (or about 3 or 3.5) as determined by Raman spectroscopy. In further or separate embodiments, the carbon material exhibits a d-spacing of 0.36-0.5, or more particularly, 0.36-0.46, 0.36-0.42, or about 0.38. In further or separate embodiments, the carbon material includes closed nanovoids (i.e., non-porous nanovoids). In further or separate embodiments, the carbon material excludes closed nanovoids. In further or separate embodiments, the carbon material possesses a 9-10 vol% pore micropore volume. In further or separate embodiments, the carbon material possesses a surface area of precisely or about, for example, 10, 20, 30, 40, 50, 60, 70, 80, 90, or 100 m²/g, or a surface area within a range bounded by any two of the foregoing values (e.g., 10-100 m²/g, 20-100 m²/g, or 50-100 m²/g). The surface area is typically a Brunauer-Emmett-Teller (BET) surface area. In further or separate embodiments, the carbon material possesses a purity of at least 90, 92, 95, 97, 98, or 99 wt.% carbon, the remaining wt.% (e.g., up to or less than 10 wt.%) attributed to oxygen. In further or separate embodiments, the carbon material exhibits a capacity of sodium storage of at least or greater than 250, 300, or 350 mAh/g at a current density of 20-40 mA/g or about 30 mA/g. In further or separate embodiments, the carbon material exhibits a stable capacity of at least or over 200 or 250 mAh g⁻¹ for at least or more than 2000, 2500, or 3000 cycles at a high current rate of at least or greater than 1 A g⁻¹. In separate or further embodiments, the carbon material may have an oxygen content of at least, above, up to, or less than 1 wt.%, 2 wt.%, 5 wt.%, or 10 wt.%. In separate or further embodiments, the carbon material may have a nitrogen content of at least or above 0.1 wt.%, 0.2 wt.%, 0.5 wt.%, 0.8 wt.%, 1 wt.%, 1.2 wt.%, 1.5 wt.%, 1.8 wt.%, or 2 wt.%, or a nitrogen content within a range bounded by any two of the foregoing values (e.g., 0.1-2 wt.%, 0.2-2 wt.%, 0.5-2 wt.%, 0.8-2 wt.%, 0.1-1.8 wt.%, 0.2-1.8 wt.%, 0.5-1.8 wt.%, or 0.8-1.8 wt.%). In separate or further embodiments, the carbon material possesses a total pore volume of precisely, about, or at least, for example, 0.2 cm³/g, 0.3 cm³/g, 0.4 cm³/g, 0.5 cm³/g, 0.6 cm³/g, 0.7 cm³/g, 0.8 cm³/g, 0.9 cm³/g, 1.0 cm³/g, 1.2 cm³/g, 1.5 cm³/g, 1.8 cm³/g, 2 cm³/g, 2.2 cm³/g, 2.5 cm³/g, 3.0 cm³/g, 3.5 cm³/g, 4.0 cm³/g, 4.5 cm³/g, 5.0 cm³/g, 5.5 cm³/g, or 6.0 cm³/g, or a pore volume within a range bounded by any two of these values. Moreover, any two or more of the above embodiments may be combined to result in a carbon material with a combination of physical features or properties.

In another aspect, the present disclosure is directed to a sodium-ion or potassium-ion battery (or sodium metal or potassium battery) containing any of the above-described carbon materials in an anode of the battery. The carbon material in the anode of the battery may include any combination of physical features and/or properties enumerated earlier above, which may be selected from any of the first through thirteenth embodiments (or elsewhere) as provided earlier above. The battery contains, at minimum, an anode, a cathode, and an electrolyte in contact with the anode and cathode. The electrolyte is in contact with the anode (negative electrode) and cathode (positive electrode) of the sodium-based battery. Alternatively, the electrolyte can be incorporated into a cathode of the sodium-based battery (typically admixed with a binder material), with the anode and cathode in contact with any of the above-described electrolytes. Sodium metal batteries are well known in the art, such as described in, for example, H. Sun et al., Nature Communications, 10, 3302, 2019, the contents of which are herein incorporated by reference. Sodium-ion batteries are also well known in the art, such as described in, for example, U.S. Application Publication No. 2012/0021273, and B. L. Ellis, et al., Current Opinion in Solid State and Materials Science, 16, 168-177, 2012, the contents of which are herein incorporated by reference in their entirety. In embodiments where the electrolyte is in contact with an anode and cathode of the sodium-based battery but not incorporated into the cathode, the sodium-based battery may employ, for example, a sodium inorganic material as the active material in the cathode. Some examples of sodium inorganic materials include, for example, NaFeO₂, NaMnO₂, NaNiO₂, and NaCoO₂. Other cathode materials for sodium-based batteries include transition metal chalcogenides, such as described in U.S. Patent 8,906,542, and sodium-lithium-nickel-manganese oxide materials, such as described in U.S. Patent 8,835,041, the contents of which are herein incorporated by reference in their entirety. Potassium-ion batteries are also well known in the art. See, for example, A. Eftekhari, Journal of Power Sources, 126 (1): 221–228, 2004 and P. Padigi et al., Electrochim. Acta, 166, 32-39, 2015, both of which describe potassium-ion batteries.

In another aspect, the present disclosure is directed to a method for producing the carbon material described above. In the method, a carbonaceous precursor material (i.e., “carbonaceous material” or “precursor material”) is subjected to a heating process that includes an initial gradual temperature increase at a rate of 0.5-2 °C/min to a maximum temperature within a range of 800-1300°C followed by maintaining the maximum temperature for a period of time of 1-18 hours, wherein the heating process is conducted under an inert atmosphere. In different embodiments, the rate of the initial gradual temperature increase may be precisely or about, for example, 0.5, 0.7, 1, 1.2, 1.5, 1.8, or 2 °C/min or a rate within a range bounded by any two of the foregoing values, e.g., 0.5-1.5 °C/min, 0.5-1.2 °C/min, 0.5-1 °C/min, or 0.5-0.8 °C/min. Any of the foregoing rates of the initial gradual temperature increase may be used to reach a maximum temperature within a range of 800-1300°C. In different embodiments, the maximum temperature may be precisely or about, for example, 800°C, 850°C, 900°C, 950°C, 1000°C, 1050°C, 1100°C, 1150°C, 1200°C, 1250°C, or 1300°C, or the maximum temperature is within a range bounded by any two of the foregoing temperatures, e.g., 800-1300°C, 850-1300°C, 900-1300°C, 950-1300°C, 1000-1300°C, 1050-1300°C, 1100-1300°C, 1150-1300°C, 1200-1300°C, 1250-1300°C, 800-1200°C, 850-1200°C, 900-1200°C, 950-1200°C, 1000-1200°C, 1050-1200°C, 1100-1200°C, 1150-1200°C, 800-1150°C, 850-1150°C, 900-1150°C, 950-1150°C, 1000-1150°C, 1050-1150°C, 1100-1150°C, 800-1100°C, 850-1100°C, 900-1100°C, 950-1100°C, 1000-1100°C, 1050-1100°C, 800-1000°C, 850-1000°C, 900-1000°C, 950-1000°C, 800-950°C, 850-950°C, 900-950°C, 800-900°C, or 850-900°C. Any rate of temperature increase provided above (or a rate within any range provided thereof) may be used to reach any maximum temperature provided above (or a maximum temperature within any range provided above).

In some embodiments, prior to the initial gradual temperature increase, the heating process includes a fast heating step at a rate of at least 5°C/min up to an intermediate temperature at or below 900°C, after which the initial gradual temperature increase (as described above) brings the intermediate temperature to the maximum temperature. The fast heating step typically raises the temperature of the carbonaceous precursor material from room temperature (typically, precisely or about 15-30°C or about 25°C) to the intermediate temperature. In different embodiments, the rate of the fast heating step may be precisely or about, for example, 5°C/min, 10°C/min, 15°C/min, 20°C/min, 25°C/min, or 30°C/min, or the rate of the fast heating step may be within a range bounded by any two of the foregoing values, e.g., 5-30 °C/min, 10-30 °C/min, 15-30 °C/min, 20-30 °C/min, 5-20 °C/min, 10-20 °C/min, 15-20 °C/min, 5-15 °C/min, or 10-15 °C/min. Any of the foregoing rates of the fast heating step may be used to reach a temperature at or below 900°C, after which the initial gradual temperature increase (as described above) brings the temperature to the maximum temperature. In different embodiments, the fast heating step raises the temperature of the carbonaceous precursor material from room temperature to an intermediate temperature at or below, for example, 900°C, 850°C, 800°C, 750°C, 700°C, 650°C, 600°C, 550°C, 500°C, 450°C, 400°C, 350°C, 300°C, 250°C, 200°C, 150°C, or 100°C, after which the initial gradual temperature increase (as described above) brings the temperature to the maximum temperature.

The phrase “maintaining the maximum temperature for a period of time of” is herein understood to mean that the precursor material is subjected to one or more temperatures of at least 800°C (more typically, within a range of 800-1300°C) for a period of time that results in conversion of the precursor material to the carbon material described above. Thus, the phrase “maintaining the maximum temperature within the range of 800-1300°C for a period of time of 1-18 hours” is understood to mean that the precursor material is subjected to one or more temperatures within the range of 800-1300°C for a period of time of 1-18 hours. In different embodiments, the period of time may be precisely or about, for example, 1, 2, 3, 6, 9, 12, 15, or 18 hours, or a period of time within a range bounded by any of the foregoing values (e.g., 1-18, 1-12, 1-6, 3-18, 3-12, 3-6, 6-18, or 6-12 hours). Notably, the maximum temperature and period of time are appropriately selected to result in conversion of the precursor material to the carbon material described above. Typically, a lower maximum temperature requires a greater period of time to result in conversion of the precursor material to the carbon material compared to a higher maximum temperature. Generally, the conditions are selected such that the resulting carbon material is at least 90 wt.% elemental carbon. The resulting carbon material is typically completely carbonized (100 wt.% elemental carbon) although partially carbonized carbon material may be produced, wherein partially carbonized carbon material generally contains at least 90 wt.% but less than 100 wt.% carbon. In different embodiments,

In some embodiments, the precursor material is heated to and maintained at a single maximum temperature within a range of 800-1300°C or sub-range therein for a period of at 1-18 hours. The term “single maximum temperature” includes the possibility of a precise single temperature (e.g., precisely 1100°C), or alternatively, a substantially uniform temperature during the maintaining period that is permitted to slightly vary by no more than ±1%, ±0.5%, ±0.2%, or ±0.1%, from a given temperature within the range of 800-1300°C, such as a temperature of 1100°C ± 1%, which corresponds to a permitted temperature variation of 1089-1111°C, or for example, 1100°C ± 0.1%, which corresponds to a permitted temperature variation of 1099-1112°C. In other embodiments, the precursor material is heated to a first temperature within a range of 800-1300°C followed by heating the precursor material to a second temperature within a range of 800-1300°C, wherein the second temperature may be higher or lower than the first temperature, and the first and second temperatures are typically separated by at least 15, 25, or 50°C. In the foregoing embodiment, the first and second temperatures may be suddenly or gradually transitioned to each other with substantially no dwell time at each temperature, or alternatively, the first and second temperatures may each be maintained for a period of time as described above. The heating process may, if desired, include additional (e.g., third, fourth, etc.) temperatures within a range of 800-1300°C at which the precursor material is subjected to.

Preferably, the heating process is conducted under an inert atmosphere, which typically contains argon or nitrogen in a predominant amount relative to oxygen. In some embodiments, the inert atmosphere is substantially or completely oxygen free. Although the controlled carbonization was conducted in an inert atmosphere, pre-carbonization and oxidation of waste materials was conducted in the presence of oxygen, which will introduce oxygen functional groups in the pre-carbonized materials. These oxygen atoms will not be completely removed during the controlled carbonization step, and thus contribute to the residual oxygen functional group in the final hard carbon materials.

The precursor material can be any carbonaceous (i.e., carbon-containing) material having the ability to become carbonized at an elevated temperature. For purposes of the invention, the elevated temperature that induces carbonization is within a range of 800-1300°C. In one set of embodiments, the precursor material is biomass. Generally, the biomass is plant-derived, i.e., cellulosic or lignocellulosic vegetation. Some particular examples of biomass materials considered herein include, for example, corn stover (e.g., the leaves, husks, stalks, or cobs of corn plants), grasses (e.g., switchgrass, miscanthus, wheat straw, rice straw, barley straw, alfalfa, bamboo, or hemp), sugarcane, hull or shell material (e.g., peanut, rice, and walnut hulls), flax (e.g., flax straw), woodchips, saw dust, paper or wood pulp, food waste, agricultural waste, and forest waste. If wood biomass is used, the wood may be a softwood or hardwood. The biomass may or may not include a lignin, such as a Kraft lignin, sulfite lignin (i.e., lignosulfonate), or a sulfur-free lignin. In another set of embodiments, the precursor material is a plastic, typically a waste plastic. The plastic may be a thermoplastic or thermoset. Some examples of thermoplastic plastics that may be used as a precursor material, either alone or in a mixture, include polyesters (e.g., PET, PETG, PLA, PGA, PHA, PBS, polycarbonate (PC) and copolymers and mixtures thereof), rubbers (e.g., acrylonitrile-containing copolymer, such as PAN, ABS, or isoprene-containing rubber), polyolefins (e.g., polyethylene, polypropylene, LDPE, HDPE, PVC, PVDF, acrylics, polystyrene, or copolymer thereof), and nylons. Some examples of thermoset plastics include epoxies, polyurethanes, phenol-formaldehyde, urea-formaldehyde, and melamine. In some embodiments, a mixture of at least two different types of biomass is used as the precursor material, or a mixture of at least two different types of plastic is used as the precursor material, or a combination of at least one type of biomass and at least one type of plastic is used as the precursor material. Any two or more specific types of biomass and/or plastic provided above (e.g., lignin and PAN) may be used as the precursor material.

Examples have been set forth below for the purpose of illustration and to describe certain specific embodiments of the invention. However, the scope of this invention is not to be in any way limited by the examples set forth herein.

### EXAMPLES

Production of Carbon Material Containing a Finely Tuned Microstructure

The following examples describe a novel sintering approach of biomass or plastic waste to produce hard carbon with a finely tuned microstructure. The microstructure of the hard carbon advantageously provides for efficient sodium-ion storage at low voltages. The hard carbon described herein can be incorporated into a battery anode to provide a superior performance. The hard carbon anode may be specifically designed for use in a high-energy density SIB.

The novel sintering approach includes the controlled sintering of partially carbonized material from biomass or plastic waste sources at varying temperatures. As further discussed below, to assess the material’s performance as an anode for sodium-ion batteries (SIBs), the resulting hard carbon material was characterized using advanced techniques, such as X-ray diffraction (XRD), Raman spectroscopy, scanning electron microscopy (SEM), transmission electron microscopy (TEM), X-ray photoelectron spectroscopy (XPS), and various electrochemical methods, including cyclic voltammetry (CV) and impedance spectroscopy. The synthesized hard carbon demonstrates excellent potential as an anode material, offering high energy and power densities for SIBs. This method can reduce costs and permit the production of affordable, high-energy-density SIBs, which can benefit such sectors as grid storage, consumer electronics, and electric vehicles.

In some experiments, partially carbonized material derived from biomass and/or plastic waste was treated at a high temperature (such as 1100 °C for 12 hours) under an inert atmosphere using a controlled heating rate to transform the partially carbonized material into the novel hard carbon having a finely tuned microstructure. This process converts the partially carbonized biomass and plastic waste into a cost-effective, high-energy density material suitable for SIB applications. In example 1 (FIGS. 1a-1b), partially carbonized biomass waste was converted into a customized hard carbon structure through sintering at 1100 °C with a ramping rate of 0.5 °C/min for 12 hours under an inert atmosphere. The resulting material exhibited a controlled microstructure with an amorphous carbon phase, as indicated by weak X-ray diffraction (XRD) reflections as plotted in FIG. 1a. Additionally, as shown by the data in FIG. 1b, the Raman spectrum (FIG. 1b) revealed a significant increase in defects, with a higher I_{D}/I_{G} ratio (~3.2), which confirms the creation of a defect-rich structure. These findings underscore the potential of waste-derived hard carbon for high-performance SIB applications.

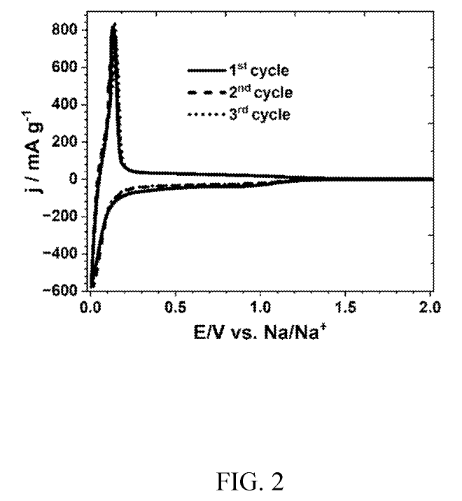

The cyclic voltammetry (CV) plot of the hard carbon synthesized from biomass at ~ 1100 °C in FIG. 2 illustrates two distinct sodium storage mechanisms in the customized hard carbon anode. A sloping sodium storage profile is observed from approximately 1.2 V to 0.15 V, followed by a plateau voltage profile below 0.15 V. This behavior is crucial for achieving high-voltage, high-energy-density SIBs. The nearly overlapping CV curves suggest that the sodium-ion storage process in this hard carbon anode is highly reversible, which indicates excellent cycling stability and efficient ion transport. These characteristics are essential for the development of long-lasting and high-performance SIBs.

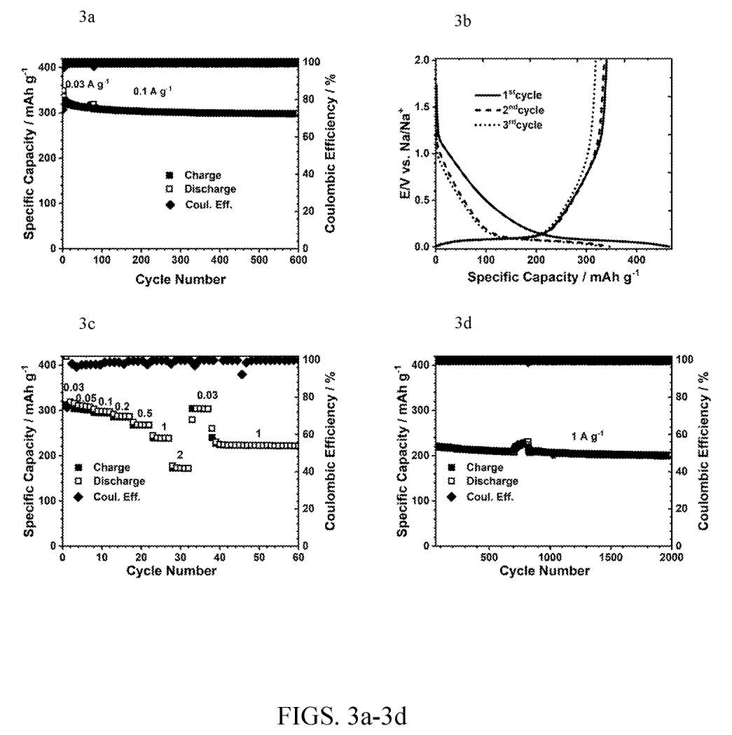

The synthesized hard carbon exhibited a specific capacity of over 335 mAh g⁻¹ with ~ 194 mAh g⁻¹ from low voltage plateau capacity and ~141 mAh g⁻¹ capacity from slope voltage region at a current density of 30mA g⁻¹, with a first cycle coulombic efficiency exceeding 75%. As shown in FIG. 3a, at a higher current density of 100mA g⁻¹, the hard carbon maintained a stable capacity of more than 300mAh g⁻¹, which is comparable to the performance of graphite anodes used in LIBs. As depicted in FIG. 3b, the anode demonstrated a low voltage sodium storage capacity below 0.1 V, along with a sloping sodium-ion storage profile. This behavior is a critical characteristic for achieving high-energy-density SIBs, and not all types of hard carbon exhibit this feature. The observed electrochemical performance indicates that the hard carbon has a well-controlled pore structure. Furthermore, as shown by the data in FIGS. 3c and 3d, the anode showed excellent rate capability, thereby delivering a stable capacity of over 200mAh g⁻¹ for 2000 cycles at a high current rate of 1 A g⁻¹. This remarkable stability indicates that the hard carbon anode derived from waste materials could play a significant role in the development of fast-charging SIBs, thus offering both high energy density and long cycle life for various applications at low cost.

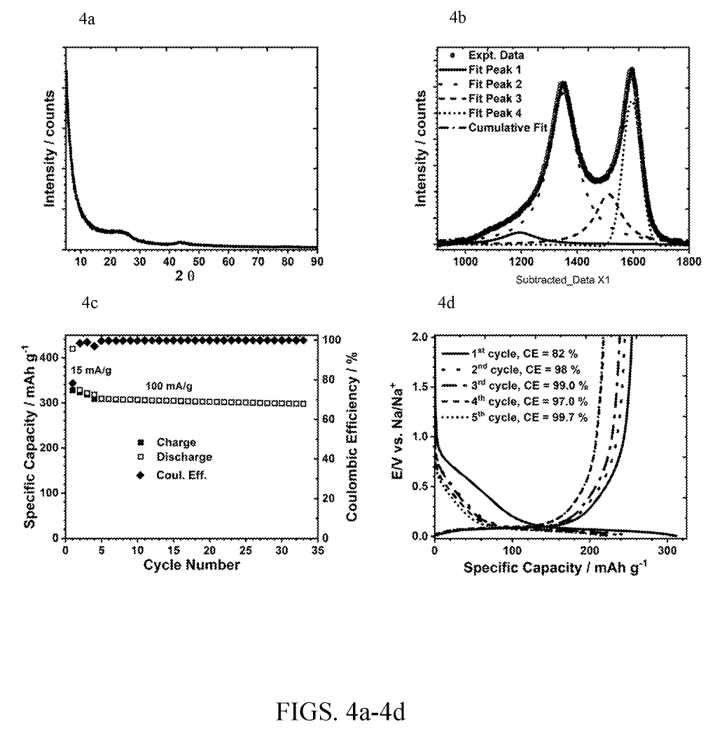

Similarly, in example 2 (FIGS. 4(a-d), partially oxidized recycled plastic waste was converted to the customized hard carbon by sintering at 1300 °C for 5 hours at a ramp rate of 0.5 °C/minutes, which demonstrated electrochemical performance comparable to that of other anodes for SIBs. The results are shown in FIGS. 4a-4d. This finding indicates that plastic waste could serve as a valuable and cost-effective resource for producing high-energy density SIB anode materials. This approach not only provides an alternative source for hard carbon but also contributes to sustainable recycling practices by transforming waste materials into high-performance components for energy storage systems.

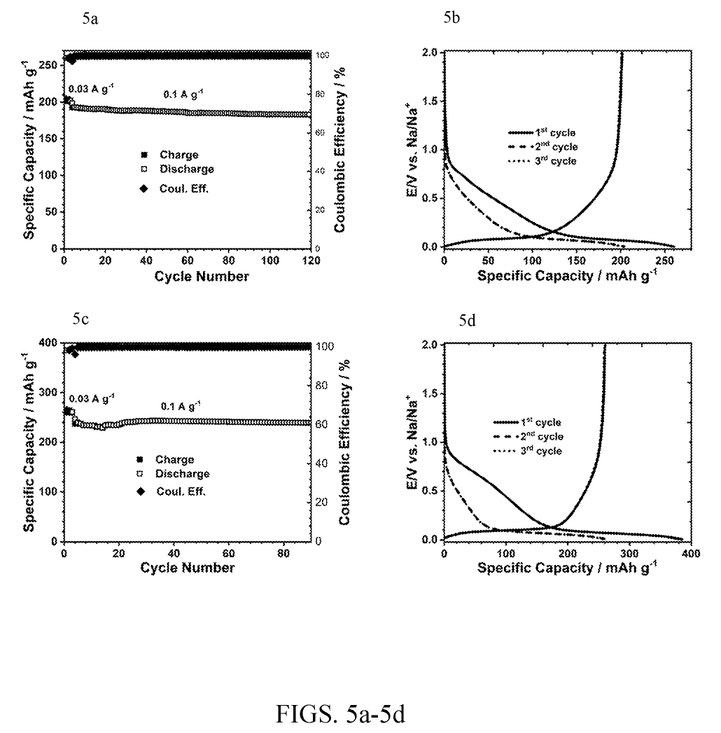

In example 3 (FIGS. 5(a-d)), the customized hard carbon was synthesized from partially carbonized polyacrylonitrile and lignin by sintering at 1100 °C for 5 hours at a heating rate of 1 °C/minutes. As shown by the data in FIGS. 5a-5d, the resulting hard carbon demonstrated electrochemical performance comparable to that of other anodes for SIBs. This finding indicates that all of the carbon forming precursors could serve as a valuable and cost-effective resource for producing high-energy density SIB anode materials. This approach not only provides an alternative source for hard carbon but also contributes to sustainable recycling practices by transforming waste materials into high-performance components for energy storage systems.

In conclusion, the above work has successfully demonstrated a high-performance customized hard carbon anode derived from biomass and plastic waste, specifically designed for high-energy density SIB applications. Key advantages of this approach include reduced production costs and the ability to fine-tune the process to optimize the properties of the synthesized hard carbon. Characterization of the material reveals the formation of a controlled porous structure, shaped by randomly oriented graphene nanodomains. This waste-derived hard carbon is more cost-effective than commercially available alternatives and exhibits superior electrochemical performance. Additionally, its properties make it an excellent candidate for fast-charging SIBs, paving the way for cost-efficient, high energy/power density batteries suitable for use in electric vehicles and other advanced applications.

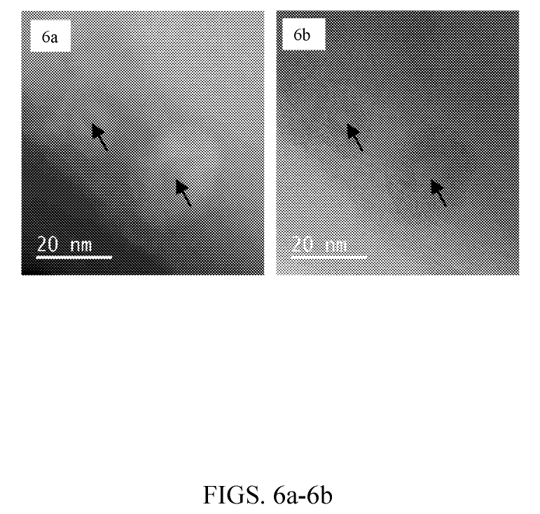

High resolution scanning transmission electron microscopy images (annular dark field (FIG. 6a) and bright field (FIG. 6b) images) of hard carbon structures prepared at ~ 1100 °C show the presence of semi-closed nanovoids, as pointed out by black arrows in the images. These semi-closed nanovoids are responsible for the low voltage sodium storage that produces the plateau capacity as depicted in the FIG. 3b. These unique structures are important for high energy density SIB anodes because the semi-closed nanovoids store sodium at low voltage, which results in a plateau profile having higher energy density sodium ion anodes. These nanovoids are connected by microchannels, which facilitate the high rate capability of hard carbon anode prepared at ~ 1100 °C.

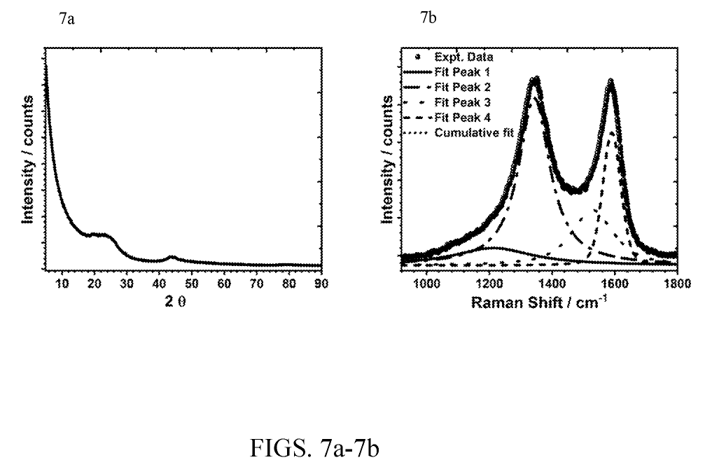

Similarly, in example 4 (FIG. 7a-7b), partially carbonized biomass waste was converted into a customized hard carbon structure by sintering at 1300 °C with a ramping rate of 0.5 °C/min for 12 hours under an inert atmosphere. The resulting material exhibited a controlled microstructure with an amorphous carbon phase, as indicated by weak X-ray diffraction (XRD) reflections as plotted in FIG. 7a. Additionally, as shown by the data in FIG. 7b, the Raman spectrum (FIG. 7b) revealed a significant increase in defects, with a higher I_{D}/I_{G} ratio (~2.6), but slightly lower defects than the hard carbon prepared at 1100 °C in example 1 (FIGS. 1a-1b) because of the loss of microporosity. These findings underscore the potential of waste-derived hard carbon for high-performance SIB applications.

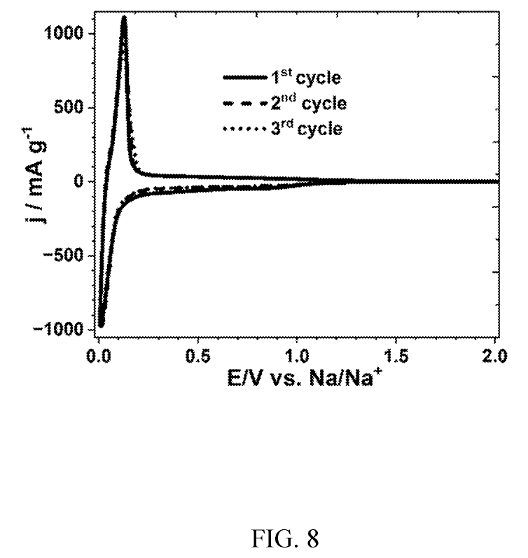

The cyclic voltammetry (CV) plot of the hard carbon synthesized from biomass at ~ 1300 °C in FIG. 8 illustrates two distinct sodium storage mechanisms in the customized hard carbon anode ‒ a sloping sodium storage profile is observed from approximately 1.2 V to 0.15 V, followed by a plateau voltage profile below 0.15 V. This behavior is crucial for achieving high-voltage, high-energy-density SIBs. The nearly overlapping CV curves suggest that the sodium-ion storage process in this hard carbon anode is highly reversible, which indicates excellent cycling stability and efficient ion transport. These characteristics are essential for the development of long-lasting and high-performance SIBs.

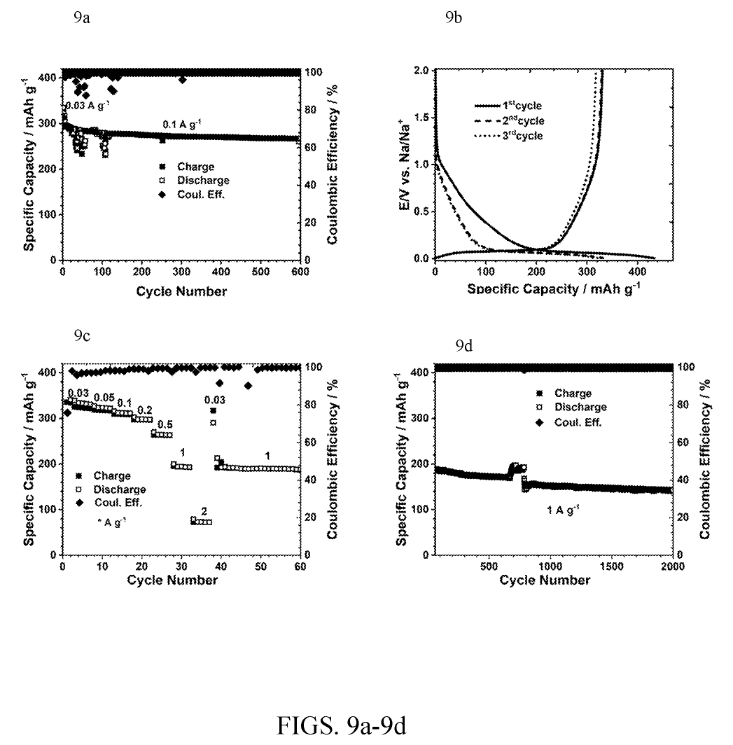

The synthesized hard carbon exhibited a specific capacity of over 329 mAh g⁻¹ with ~ 219.0 mAh g⁻¹ capacity from plateau region and ~ 109.0 mAh g⁻¹ capacity from slope region at a current density of 30 mA g⁻¹, with a first cycle coulombic efficiency exceeding 80%. As shown in FIG. 9a, at a higher current density of 100 mA g⁻¹, the hard carbon maintained a stable capacity of ~267 mAh g⁻¹, which is comparable to the performance of graphite anodes used in LIBs (FIG. 3a). This slightly lower long cycling capacity of hard carbon prepared at 1300 °C compared to hard carbon prepared at 1100 °C is because of the loss of micropore channels that connect the semi-closed nanovoids which slows down the diffusion kinetics. As depicted in FIG. 9b, the anode demonstrated a low voltage sodium storage capacity below 0.1 V, along with a sloping sodium-ion storage profile. This behavior is a critical characteristic for achieving high-energy-density SIBs, and not all types of hard carbon exhibit this feature. The observed electrochemical performance indicates that the hard carbon has a well-controlled pore structure. Furthermore, as shown by the data in FIGS. 9c and 9d, the anode showed long term stable capacity of 143 mAh g⁻¹ for 2000 cycles at a high current rate of 1 A g⁻¹, which is slightly lower compared to the carbon prepared at 1100 °C (FIGS. 3a-3d). This difference in high current rate capability indicates the importance of the microchannels that connect the semi-closed nanovoids in the carbon structure prepared at 1100 °C but absent in the carbon prepared at higher temperatures.

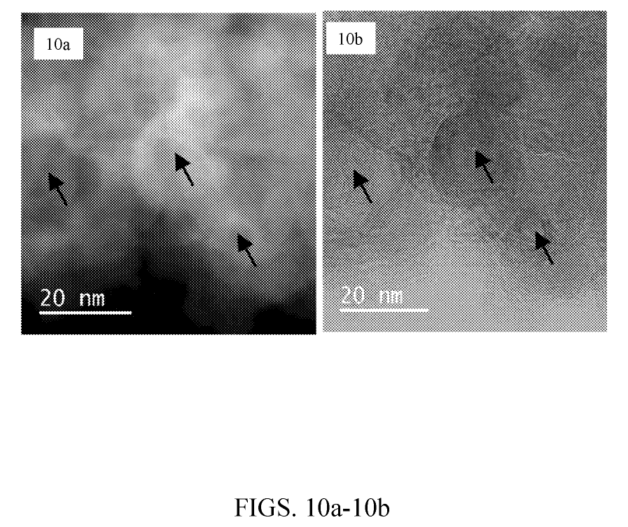

The high resolution scanning transmission electron microscopy images (annular dark field (FIG. 10a) and bright field (FIG. 10b) images) of hard carbon structures prepared at ~ 1300 °C show the presence of semi-closed nanovoids as pointed out by black arrows in the images. These semi-closed nanovoids are responsible for the low voltage sodium storage that produces the plateau capacity as depicted in FIG. 9b. These unique structures are important for high energy density SIB anode because these unique semi-closed nanovoids are responsible for the low voltage sodium storage which enhance the energy density of the battery. However, these nanovoids are not directly interconnected because of the loss of microporosity that resulted in the low capacity at high rate capability (FIG. 9d) compared to hard carbon anode prepared at ~ 1100 °C which has microchannels that connects these nanovoids.

While there have been shown and described what are at present considered the preferred embodiments of the invention, those skilled in the art may make various changes and modifications which remain within the scope of the invention defined by the appended claims.

What is claimed is:

1. A composition useful as a sodium-ion battery anode material, the composition comprising an amorphous carbon material containing randomly oriented graphene platelets along with the following additional features: (i) nanovoids contoured by layers of the graphene platelets, wherein the nanovoids have a size of 2-20 nm; (ii) sub-nanopores that traverse said layers and having a size of 0.2-0.6 nm; and (iii) microchannels connecting between said nanovoids, wherein said microchannels have a width less than 2 nm.

2. The composition of claim 1, wherein said nanovoids have a size of 2-5 nm.

3. The composition of claim 1, wherein said sub-nanopores have a size of 0.3-0.6 nm.

4. The composition of claim 1, wherein said microchannels have a width of 0.1-0.7 nm.

5. The composition of claim 1, wherein said microchannels have a width of 0.1-0.5 nm.

6. The composition of claim 1, wherein the amorphous carbon material excludes pores larger than 1 nm.

7. The composition of claim 1, wherein the amorphous carbon material includes sodium atoms.

8. The composition of claim 1, wherein the amorphous carbon material has a defect-rich structure characterized by a D-band to G-band intensity (I_{D}/I_{G}) ratio in a range of 2-4 as determined by Raman spectroscopy.

9. The composition of claim 1, wherein the amorphous carbon material has a d-spacing of 0.36-0.5.

10. A sodium-ion or potassium-ion battery comprising:
(a) an anode;
(b) a cathode; and
(c) an electrolyte composition in contact with said anode and cathode;
wherein said anode comprises an amorphous carbon material containing randomly oriented graphene platelets along with the following additional features: (i) nanovoids contoured by layers of the graphene platelets, wherein the nanovoids have a size of 2-20 nm; (ii) sub-nanopores that traverse said layers and having a size of 0.2-0.6 nm; and (iii) microchannels connecting between said nanovoids, wherein said microchannels have a width less than 2 nm.

11. The sodium-ion or potassium-ion battery of claim 10, wherein said nanovoids have a size of 2-5 nm.

12. The sodium-ion or potassium-ion battery of claim 10, wherein said sub-nanopores have a size of 0.3-0.6 nm.

13. The sodium-ion or potassium-ion battery of claim 10, wherein said microchannels have a width of 0.1-0.7 nm.

14. The sodium-ion or potassium-ion battery of claim 10, wherein said microchannels have a width of 0.1-0.5 nm.

15. The sodium-ion or potassium-ion battery of claim 10, wherein the amorphous carbon material excludes pores larger than 1 nm on said graphene surfaces.

16. The sodium-ion or potassium-ion battery of claim 10, wherein the amorphous carbon material has a defect-rich structure characterized by a D-band to G-band intensity (I_{D}/I_{G}) ratio in a range of 2-4 as determined by Raman spectroscopy.

17. The sodium-ion or potassium-ion battery of claim 10, wherein the amorphous carbon material has a d-spacing of 0.36-0.5.

18. A method of producing an amorphous carbon material useful as a sodium-ion battery anode material, the method comprising subjecting a carbonaceous precursor material to a heating process that includes an initial gradual temperature increase at a rate of 0.5-2 °C/min to a maximum temperature within a range of 800-1300°C followed by maintaining the maximum temperature for a period of time of 1-18 hours, wherein the heating process is conducted under an inert atmosphere, and wherein the resulting amorphous carbon material contains randomly oriented graphene platelets along with the following additional features: (i) nanovoids contoured by layers of the graphene platelets, wherein the nanovoids have a size of 2-20 nm; (ii) sub-nanopores that traverse said layers and having a size of 0.2-0.6 nm; and (iii) microchannels connecting between said nanovoids, wherein said microchannels have a width less than 2 nm.

19. The method of claim 18, wherein the initial gradual temperature increase is conducted at a rate of 0.5-1 °C/min.

20. The method of claim 18, wherein the maximum temperature is within a range of 900-1200°C.

21. The method of claim 18, wherein the maximum temperature is within a range of 1000-1200°C.

22. The method of claim 18, wherein the maximum temperature is within a range of 1050-1150°C.

23. The method of claim 18, wherein the maximum temperature is maintained for a period of time of 6-18 hours.

24. The method of claim 18, wherein, prior to the initial gradual temperature increase, the heating process includes a fast heating step at a rate of at least 5°C/min up to an intermediate temperature at or below 900°C, after which the initial gradual temperature increase brings the intermediate temperature to the maximum temperature.

25. The method of claim 23, wherein the fast heating step is conducted at a rate of at least 10°C/min.
